(19) United States
(12) Patent Application Publication
(10) Pub. No.: US 2003/0003420 A1
(43) Pub. Date: Jan. 2, 2003

(54) Process for producing a dental prosthesis

(75) Inventor: Roland Striezel, Lilienthal (DE)

Correspondence Address: ALTERA LAW GROUP, LLC, 6500 CITY WEST PARKWAY, SUITE 100, MINNEAPOLIS, MN, 55344-7704, US

(73) Assignee: BEGO Bremer Goldschlagerei, Bremen (DE)

(21) Appl. No.: 10/185,931

(22) Filed: Jun. 27, 2002

(30) Foreign Application Priority Data
Jun. 28, 2001 (DE) 101 31 131.1

(51) Int. Cl. A61C 11/00

(52) U.S. Cl. 433/213

(57) ABSTRACT

In a process for producing a dental prosthesis as a (partial) substitute for individual teeth or groups of teeth in the dental arch of a jaw with intraoral recording of the spatial information in respect of the tooth stump, implant or the like which receives the prosthesis, recording of the items of information is also extended to the adjacent teeth of the prosthesis to be produced, and at least the region of the jaw which is affected thereby. A model of the jaw or jaw portion with the adjacent teeth is prepared by means of those items of information and independently thereof a support structure for the prosthesis, which is adapted to the tooth stump or the like, is produced from a part of the items of information. Thereafter the prosthesis is prepared on the support structure with adaptation to the adjacent teeth.

The invention concerns a process for producing a dental prosthesis as a (partial) substitute for individual teeth or groups of teeth in the dental arch of a jaw with intraoral recording of the spatial information in respect of the tooth stump, implant or the like which receives the prosthesis.

It is known for the spatial configuration of a carrier for a tooth prosthesis, which is anchored in the jaw, to be scanned, recorded and stored in order to be able to use the information obtained in that way (data) to configure the spatial internal contour which is to be matched to the carrier, upon production of the tooth prosthesis (via DE 198 28 003 A1). The latter applies for example for crowns and caps as well as onlays while the outer and inner contours are interchanged in the case of a tooth prosthesis in the form of an inlay.

The carrier may be a natural tooth stump, but also an implant which has been previously anchored in the jaw and which in particular has grown into place in the meantime. Intraoral recording of the spatial carrier configuration is nowadays generally effected by scanning and producing a file of digital data. The operation of sensing and recording the spatial shape of the carrier can however also be effected by other means, for example ultrasound, X-ray or computer tomography.

Knowledge of the ‘connecting data’ascertained in that way is sufficient for the production of onlays or inlays. That however is not the case if, for producing caps, crowns or bridges, the contact points or surfaces in relation to the adjacent teeth have to be established when configuring the external surfaces of such prostheses. In addition, when constructing bridges and/or a plurality of crowns, there must be information about the respective opposite jaw in order to take account of occlusion. Determining the contact points and occlusion (statically and dynamically) requires a high level of precision in the range of about 10 μm.

Therefore, if in particular crowns or bridges are to be produced, the state of the art still involves taking mechanical impressions of the jaw or jaws or the jaw regions in question, that is to say moldings which form negative molds for the required production of models of the jaw. That takes a considerable amount of time (including pre-processing and post-processing, about one quarter of an hour per jaw), and correspondingly stresses the patient. The impression is packaged after being disinfected and sent to the dental laboratory where it serves for production of the model by a dental technician. The desired prosthesis is then produced on the model or models. It is also known for the jaw models produced by means of conventional molding procedures to be digitised, that is to say for their spatial shape and spatial association to be digitally recorded and stored in a data file (WO 01/41670).

The invention seeks to lastingly simplify that procedure. It provides that intraoral recording of the items of information is also extended to the adjacent teeth of the prosthesis to be produced, and at least the region of the jaw which is affected thereby, that a model of the jaw or jaw portion with the adjacent teeth is prepared by means of those items of information, that independently thereof a support structure for the prosthesis, which is adapted to the tooth stump or the like, is produced from a part of the items of information, and thereafter the prosthesis is prepared on the support structure with adaptation to the adjacent teeth.

In that way, in the context of a single (intraoral) scanning procedure, it is possible to obtain not only a storable recording of the internal configuration, which is adapted to the carrier, of the tooth substitute to be prepared, but virtually at the same time also a data file of the spatial external configuration of the adjoining teeth and possibly that of the other jaw. From the point of view of the patient that operation requires a fraction of the time required for the conventional procedure for taking an impression. Without additional processing operations being required, the intraorally scanned recording can be passed to a dental laboratory, more specifically most easily and most quickly using telecommunication means. By means of those data the recipient produces both a model of the jaw or jaw region affected (and possibly the other jaw or jaw region) and also the desired tooth prosthesis or initially a support structure for same. By means of the available data (or a part which is coupled out of same) the external configuration of the prosthesis can be substantially adapted in relation to the adjacent teeth or the counter-bite, upon production of the prosthesis, on the basis of the model and possibly the support structure. Only little finishing work needs to be done on the model. Static and/or dynamic occlusion can be structurally taken into consideration (possibly by calculation). The immediate manufacturing expenditure for the dental prosthesis and thus the cost thereof are correspondingly reduced.

It is essential in that respect that both production of the model and also production of the support structure can be effected virtually industrially and thus quickly, accurately and inexpensively while then the prosthesis is at least substantially manually prepared so that the dental technician can take account of all individual circumstances, not least on the basis of his experience. This naturally expensive measure however remains limited to the part of the entire production process where it is actually required.

Preparation of the model and/or the support structure can be implemented more specifically by means of ‘Rapid Prototyping’which is controlled by the information (data), that is to say for example by milling but also a laminate structure by means of laser sintering or by means of a 3D-printer. The support structure will generally comprise metal but it can also be made from ceramic or plastic material while the prosthesis receives its definitive form by a —manually applied —facing of ceramic (porcelain).

1. A process for producing a dental prosthesis as a (partial) substitute for individual teeth or groups of teeth in the dental arch of a jaw with intraoral recording of the spatial information in respect of the tooth stump, implant or the like which receives the prosthesis, characterised in that the intraoral recording of the items of information is also extended to the adjacent teeth of the prosthesis to be produced, and at least the region of the jaw which is affected thereby, that a model of the jaw or jaw portion with the adjacent teeth is prepared by means of those items of information, that independently thereof a support structure for the prosthesis, which is adapted to the tooth stump or the like, is produced from a part of the items of information, and thereafter the prosthesis is prepared on the support structure with adaptation to the adjacent teeth.

2. A process as set forth in claim 1 characterised in that in addition at least the affected region of the other jaw is recorded and incorporated into production of the model.

3. A process as set forth in claim 1 or claim 2 characterised in that the items of information in respect of the tooth stump or the like are coupled out of the intraorally recorded information as part thereof.

4. A process as set forth in one of the preceding claims characterised in that in preparation of the prosthesis the static and/or dynamic occlusion is ascertained from the recorded data and structurally taken into consideration.
